(19) United States
(12) Patent Application Publication
(10) Pub. No.: US 2009/0293814 A1
(43) Pub. Date: Dec. 3, 2009

(54) Fish tank cover

(76) Inventors: Richard A. Rutherford, JR., Green Cove Springs, FL (US); Judy A. Rutherford, Green Cove Springs, FL (US); Richard A. Rutherford, III, Fleming Island, FL (US); Jana L. Lowe, Green Cove Springs, FL (US)

Correspondence Address: LAW OFFICE OF L. JACK GIBNEY, 8777 SAN JOSE BLVD., SUITE 502, JACKSONVILLE, FL, 32217, US

(21) Appl. No.: 12/131,945

(22) Filed: Jun. 3, 2008

(51) Int. Cl. A01K 63/00

(52) U.S. Cl. 119/253

(57) ABSTRACT

This device will allow an aquarium to be accentuated without disturbing the internal contents of the aquarium. It will be comprised of a solid structure that will fit over the outside of an aquarium and will allow interior inspection of an aquarium without removing the device. It will also allow routine maintenance of the aquarium's parts without removing the device. It will also allow feeding of the fish, also without removing the device from over the top of the aquarium.

### BACKGROUND OF THE INVENTION

A. Field Of The Invention

This is a fish tank covering to make the fish tank more aesthetically pleasing and to hide the structure of the fish tank. The device can be made in all different designs depending on the customer preferences and desires.

B. Prior Art

There are many other prior art references to fish tank covers and fish tanks in general. Representative examples in the prior art include Tominaga, U.S. Pat. No. 4,920,922, Hoffa, U.S. Pat. No. 5,067,438, Pritchard, U.S. Pat. No. 5,327,855 Kelley, Des. 377, 242 Hilton, U.S. Pat. No. 5,752,468 Demoret U.S. Pat. No. 5,983,411 and Ong Des. 454,739.

Tominaga is an aquarium lid that will allow the individual some degree of access to the aquarium to feed the fish and perform routine maintenance to the tank. It is simply a lid and is not meant to be decorative.

Hoffa is an aquarium that will improve access to the contents of the aquarium but is not specifically intended to be decorative and is not a covering for an aquarium.

Kelly and Pritchard are different designs for aquarium.

Hilton is a decorative aquarium screen that is intended to hide the frame of the aquarium and therefore improve the aesthetic appeal of an aquarium. It does not allow access to the aquarium.

Demoret is an aquarium that takes the shape of a toilet tank. This device combines the features of a working toilet with an aquarium. the current device does not seek to combine a working device with an aquarium.

Ong is a design patent that is an aquarium covering in the shape of a tissue box. While this device certainly covers the frame of the aquarium and allows access to the interior of the aquarium, the structure of the current device prevents any fish from escaping from the opening in the top.

### BRIEF SUMMARY OF THE INVENTION

This device will be placed over an existing fish tank or aquarium. Fish tanks or aquariums are commonly used today but most have a certain utilitarian look i.e. boxy with defined side walls, defined bottom and open top. Because aquariums contain water, the frame of the aquarium tends to be made of strong, rigid material. Most aquariums also include pumps to circulate the water within the aquarium and lights. Certain background scenes may be placed on the back surface to give the aquarium a certain desired look but cannot hide the boxy, utilitarian look.

This device is a way to add distinctive features to the outside appearance of a fish tank while still maintaining the look of a fish tank and allowing individuals to view the interior of the aquarium.

This device that will cover the aquarium will have an open bottom, defined sidewalls, a back wall, and front wall as well as a defined top surface. The top surface will probably be in the form of a roof so the device will look like a house over the fish tank.

The top of the device will be hinged in the middle of the top so that an individual can access the aquarium and perform routine maintenance such as to the pumps and lights without removing the covering.

An opening in the top of the roof will allow an individual to feed or place food into the tank without the necessity of removing the device from the fish tank or opening the hinged portion of the roof.

It is an object of this device to allow the owner of the standard aquarium to add some decorative features to the aquarium without detracting from the basic functions of an aquarium and at the same time permitting ease of access to the interior of the aquarium for maintenance purposes and in order to feed the fish.

### BRIEF DESCRIPTION OF THE DRAWINGS

FIG. 1 is a front isometric view of the device placed over the aquarium.

FIG. 2 is a rear isometric view of the device and not placed over the aquarium.

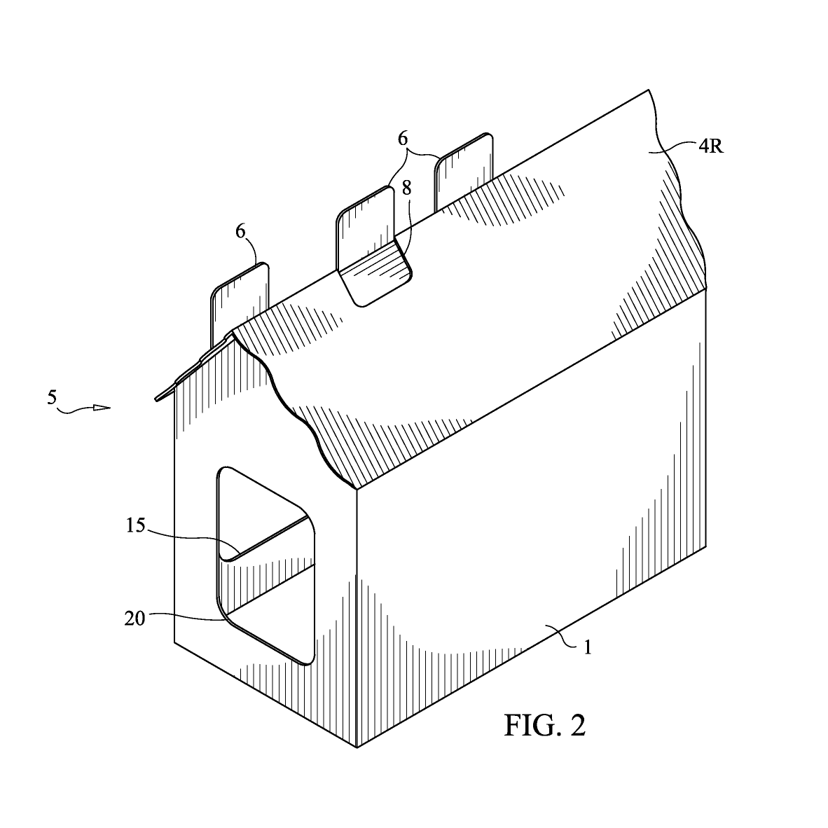

FIG. 3 is a front view of the device.

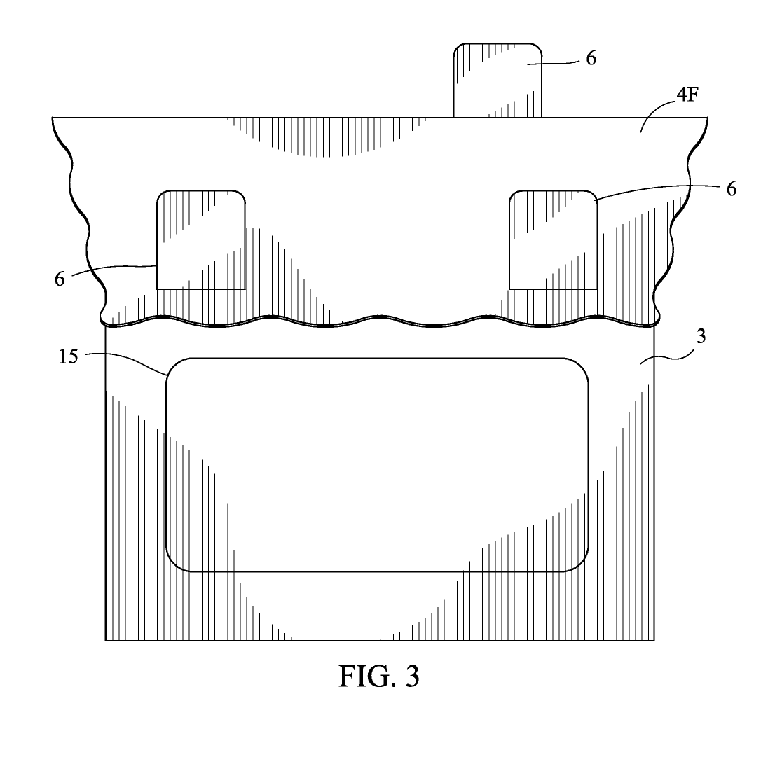

FIG. 4 is a rear view of the device.

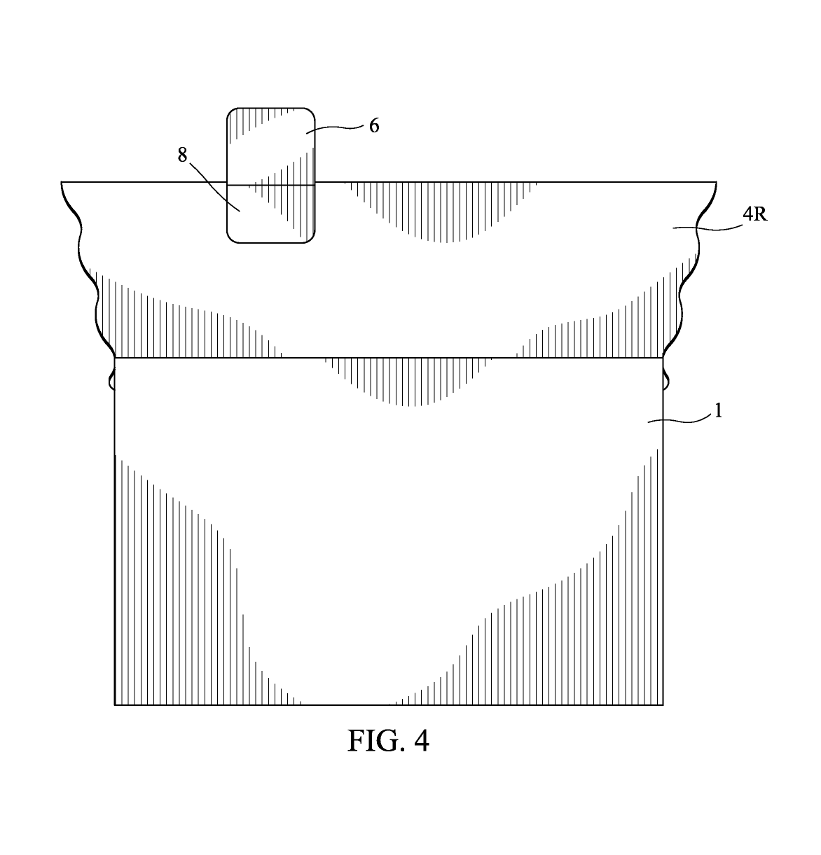

FIG. 5 is a top view of the device.

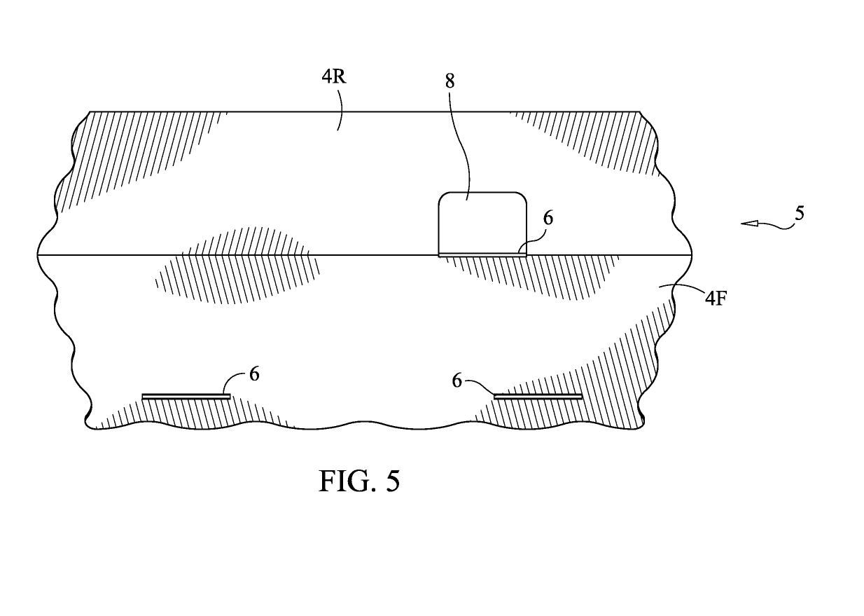

FIG. 6 is an isometric view of the device from the bottom.

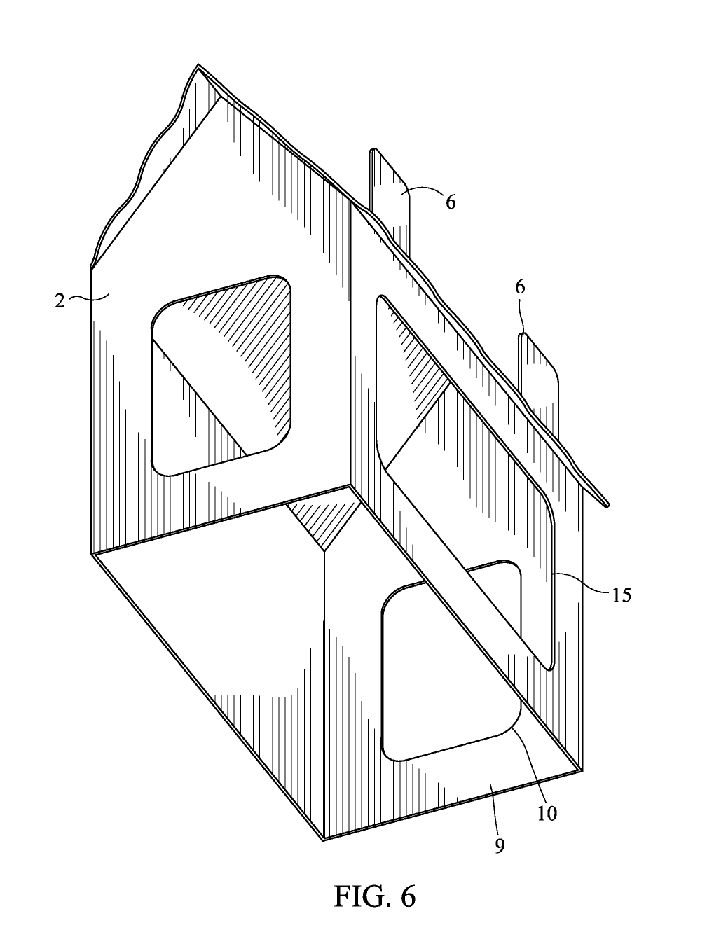

FIG. 7 is a side view of the device.

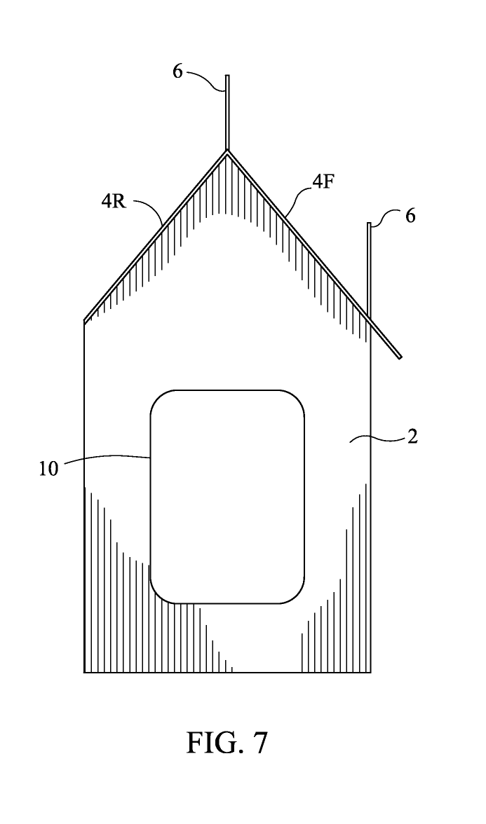

### DETAILED DESCRIPTION OF THE EMBODIMENTS

This is a fish tank cover 5. It will consist of a defined back wall 1, defined side walls 2, and a defined front opening 15. The opening in the front 15 will allow the interior contents of the aquarium to be viewed when the device is in place. It is designed to be lightweight and portable and many different exterior decorative designs may be used. Many different materials may also be used to construct the device.

The device will also have two solid top surfaces, 4R and 4F, which will be slightly sloped and in the general shape of a roof and hinged near the top near the junction of the two top surfaces, 4R and 4F. The hinge will permit roof section 4R to be lifted a predetermined amount so that routine maintenance may be performed on the aquarium equipment such as the pump and filter mechanism. These pieces of equipment are usually placed in the rear of the aquarium to hide them from view.

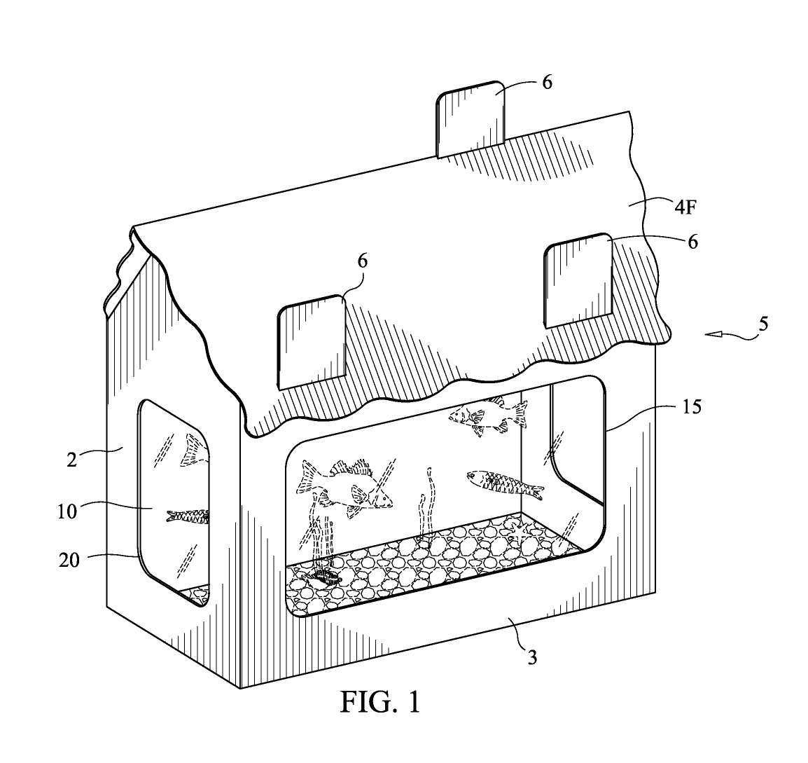

On the front surface 4F, two decorative pieces 6 may be installed that will add a decorative touch to the device. These decorative pieces 6 are added to give the feel of a roof with dormers or a chimney as depicted in FIG. 1.

Near the top of the two top surfaces will be an access opening 8 that will allow food to be added without needing to open the device or remove the device from the aquarium. The opening 8 will be large enough to allow food to be dropped into the aquarium. In order to hide the opening 8, it will most likely be on the back side on surface 4R and shielded by a decorative piece 6. When a person views the aquarium from the front the opening 8 will be hidden because of the roof shape formed by the top surfaces, 4R and 4F and the decorative piece 6.

The two top surfaces, 4R and 4F will be hinged so that a person can obtain access to interior components such as a pump or even the contents of the aquarium. Because the top surfaces are hinged, greater access is provided without requiring removal of the device from the aquarium.

Openings in the front 15 and on the sides 20 will provide adequate visual access to the interior of the aquarium. These openings may have transparent material that covers the respective opening or the openings may have no covering.

The inventor claims:

1. A fish tank cover, which is comprised of:
a. a defined rear surface;
b. a defined front surface;
c. defined sidewalls;
d. defined top surface;
e. an open bottom surface;
wherein the opening in the bottom will fit over the structure of an aquarium;
wherein the front surface has an opening;
wherein the sides have an opening;
wherein the openings on the front surface and the sides allow the interior of the aquarium to be visually inspected;
wherein the top surface is comprised of two slightly sloped surfaces;
said slightly sloped surfaces are hinged at the junction of the surfaces;
wherein an access opening is provided on a portion of one of the top surfaces;
wherein decorative pieces are placed on the front surface of the device.

2. The fish tank cover as described in claim 1 wherein coverings are placed on the openings in the front and sides.

3. The covering as described in claim 2 wherein the coverings are transparent.

4. The fish tank cover as described in claim 1 wherein the access opening is placed on the back surface of one of the slightly sloped surfaces.
